(19) United States
(12) Patent Application Publication
(10) Pub. No.: US 2023/0091534 A1
(43) Pub. Date: Mar. 23, 2023

(54) LINK ROTOR HEAD AND UNMANNED AERIAL VEHICLE

(71) Applicant: Zhuhai Edge Smart Drive Technology Co., Ltd, Zhuhai (CN)

(72) Inventors: Zhanchao ZHAI, Zhuhai (CN); Cong YAO, Zhuhai (CN)

(21) Appl. No.: 17/726,078

(22) Filed: Apr. 21, 2022

(30) Foreign Application Priority Data
Sep. 18, 2021 (CN) 202111098866.7

(51) Int. Cl. B64C 27/605; B64C 27/39; B64C 39/02

(52) U.S. Cl. CPC B64C 27/605; B64C 27/39; B64C 39/024; B64C 2201/108

(57) ABSTRACT

A link rotor head and an unmanned aerial vehicle are disclosed. The link rotor head includes a main shaft, a rotor hub arranged at an upper end of the main shaft, a rotor assembly rotatably arranged on the rotor hub, a swashplate assembly movably arranged around the main shaft, and a link assembly. The swashplate assembly drives the rotor assembly to rotate via the link assembly. The link assembly includes a phase link, a phase rocker and a pitch link. The phase rocker is rotatably arranged on the rotor hub, with one end of the phase rocker movably connected with the swashplate assembly via the phase link and with an other end of the phase rocker movably connected with the rotor assembly via the pitch link.

### CROSS-REFERENCE TO RELATED APPLICATION

This application is based on and claims the benefit of priority from Chinese Patent Application No. 2021110988667, filed on 18 Sep. 2021, the entirety of which is incorporated by reference herein.

### TECHNICAL FIELD

The disclosure relates to the technical field of aircrafts, and more particularly, to a link rotor head and an unmanned aerial vehicle.

### BACKGROUND

A rotor is a main lifting component of a helicopter. The rotor consists of a rotor head and several blades. The rotor head is mounted on a rotor shaft, and the slender blades are mounted on the rotor head. A steering engine controls a tilt angle of the blades through a pitch transmission structure, changes a pitch of the blades, and enables the helicopter to make corresponding actions.

A pitch transmission structure of an existing link rotor head includes a lower swashplate, an upper swashplate and a pitch-phase link. A steering engine controls a position and an angle of the lower swashplate, the lower swashplate drives the upper swashplate to move, the blades are connected with the upper swashplate through the pitch-phase link, and the upper swashplate changes a pitch of the blades through the pitch-phase link. Because there is no angle limit on the upper swashplate, the rotation of the blades during flying will cause the upper swashplate and the pitch-phase link to deviate to cause a phenomenon of oblique transmission, the transmission accuracy is low and the swashplates are worn seriously.

### SUMMARY

The disclosure aims at solving at least one of the technical problems in the existing technology. Therefore, the disclosure proposes a link rotor head, which can avoid a phenomenon of oblique transmission in a pitch transmission process and improve a transmission accuracy.

The disclosure further provides an unmanned aerial vehicle having the above-mentioned link rotor head.

A link rotor head according to an embodiment of a first aspect of the disclosure includes: a main shaft; a rotor hub, wherein the rotor hub is arranged at an upper end of the main shaft; a rotor assembly, wherein the rotor assembly is rotatably arranged on the rotor hub; a swashplate assembly, wherein the swashplate assembly is movably arranged around the main shaft; and a link assembly, wherein the swashplate assembly is configured for driving the rotor assembly to rotate via the link assembly, the link assembly includes a phase link, a phase rocker and a pitch link, the phase rocker is rotatably arranged on the rotor hub, one end of the phase rocker is movably connected with the swashplate assembly via the phase link, and the other end of the phase rocker is movably connected with the rotor assembly via the pitch link. The phase link is hinged with the swashplate assembly via a ball joint, the phase link is hinged with the phase rocker via a rotating shaft, the phase rocker is hinged with the pitch link via a ball joint, and the pitch link is hinged with the rotor assembly via a ball joint.

The link rotor head according to the embodiments of the disclosure at least has the following beneficial effects. Taking the link assembly on a left side of the main shaft as an example, when the swashplate assembly ascends along the main shaft, the phase link ascends to drive a rear end of the phase rocker to ascend and a front end of the phase rocker to descend, so that the pitch link descends to drive the rotor assembly to rotate. Therefore, a manipulation quantity of the steering engine is transmitted via the phase rocker, while the phase rocker is arranged on the rotor hub and the phase rocker can only rotate in a plane perpendicular to a left-right direction, so the pitch link and the phase link can only move in a plane most perpendicular to the left-right direction, and left-right deviation will not be generated, thus avoiding a phenomenon of oblique transmission during pitch transmission and improving a transmission accuracy.

According to some embodiments of the disclosure, the rotating shaft is a set screw passing through the phase link and the phase rocker, and a bearing is arranged between the set screw and the phase link.

According to some embodiments of the disclosure, the rotor assembly includes: a rotor grip, wherein the rotor grip is rotatably arranged on the rotor hub, and the pitch link is hinged with the rotor grip; and a blade, wherein the blade is arranged on one side of the rotor grip far away from the rotor hub.

According to some embodiments of the disclosure, an upper end of the pitch link is hinged with a leeward side of the rotor assembly.

According to some embodiments of the disclosure, two rotor assemblies and two link assemblies are provided, and both the two rotor assemblies and the two link assemblies are symmetrically arranged along an axis center of the main shaft.

According to some embodiments of the disclosure, the swashplate assembly includes: a lower swashplate, wherein the lower swashplate is arranged around the main shaft, and the lower swashplate is connected with a steering engine via one or more lower links; and an upper swashplate, wherein the upper swashplate is arranged around the main shaft, the upper swashplate is rotatably arranged at an upper end of the lower swashplate, and the upper swashplate is hinged with the phase link.

According to some embodiments of the disclosure, the pitch link is a plastic injection part.

An unmanned aerial vehicle according to an embodiment of a second aspect of the disclosure includes the link rotor head according to the embodiment of the first aspect of the disclosure above.

According to the unmanned aerial vehicle of the embodiment of the disclosure, by adopting the link rotor head above, heading stability is improved, operating load of parts is reduced, and service lives of the parts are prolonged.

The additional aspects and advantages of the disclosure will be partially given in the following description, and will partially become obvious from the following description, or learned through the practice of the disclosure.

### BRIEF DESCRIPTION OF THE DRAWINGS

The disclosure is further explained with reference to the drawings and embodiments hereinafter.

FIG. 1 is a schematic structural diagram of a link rotor head according to an embodiment of the disclosure;

FIG. 2 is a front view of the link rotor head shown in FIG. 1;

FIG. 3 is a left view of the link rotor head shown in FIG. 1; and

FIG. 4 is a partial enlarged view of a portion A shown in FIG. 1.

### REFERENCE NUMERALS

100 refers to main shaft;
200 refers to rotor hub;
300 refers to rotor assembly; 310 refers to rotor grip; and 320 refers to blade;
400 refers to swashplate assembly; 410 refers to lower swashplate; and 420 refers to upper swashplate;
500 refers to link assembly; 510 refers to phase link; 520 refers to phase rocker; 530 refers to pitch link; 541 refers to set screw; and 542 refers to bearing.

### DETAILED DESCRIPTION

The embodiments of the disclosure will be described in detail herein, the preferred embodiments of the disclosure are shown in the drawings, the drawings are intended to supplement the description in the written portion of the specification with figures, so that people can intuitively and vividly understand each technical feature and the overall technical solution of the disclosure, but it shall not be understood as a limitation to the protection scope of the disclosure.

In the description of the disclosure, it should be understood that the positional descriptions referred to, for example, the directional or positional relationships indicated by up, down, front, rear, left, right, etc., are based on the directional or positional relationships shown in the drawings, and are only for convenience and simplification of description of the disclosure, but not for indicating or implying that the referred device or element must have a specific direction, be constructed and operated in a specific direction, and thus should not be construed as limiting the disclosure.

In the description of the disclosure, “several” means one or more, “a plurality of” means more than two, “greater than a number”, “less than a number”, “exceed a number” and the like indicate that the number is excluded, and “above a number”, “below a number”, “within a number”, and the like indicate that the number is included. “First” and “second” if described are only used to distinguish between technical features but cannot be used to indicate or imply relative importance or implicitly specify a quantity of indicated technical features or implicitly specify a sequential relationship of indicated technical features.

In the description of the disclosure, unless otherwise expressly defined, the terms such as “disposed”, “mounted”, and “connected” should be understood in a broad sense. For persons of ordinary skill in the art, specific meanings of the terms in the disclosure may be appropriately determined with reference to the specific content in the technical solution.

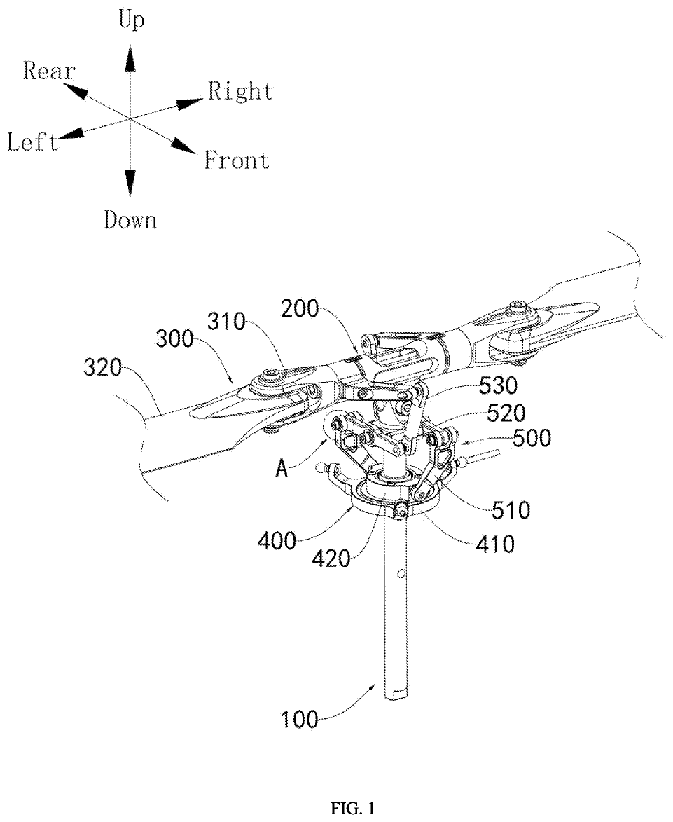

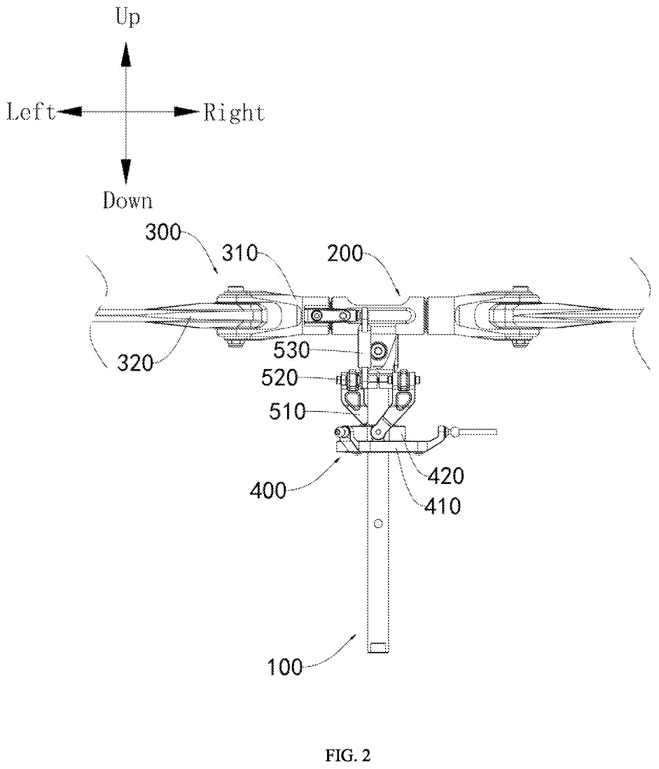

Referring to FIG. 1 to FIG. 4, a link rotor head according to the embodiments of the disclosure are described.

As shown in FIG. 1 to FIG. 3, the link rotor head according to the embodiments of the disclosure includes: a main shaft 100, a rotor hub 200, a rotor assembly 300, a swashplate assembly 400 and a link assembly 500. The rotor hub 200 is arranged at an upper end of the main shaft 100; the rotor assembly 300 is rotatably arranged on the rotor hub 200; the swashplate assembly 400 is movably arranged around the main shaft 100; the swashplate assembly 400 drives the rotor assembly 300 to rotate via the link assembly 500, the link assembly 500 includes a phase link 510, a phase rocker 520 and a pitch link 530, the phase rocker 520 is rotatably arranged on the rotor hub 200, one end of the phase rocker 520 is movably connected with the swashplate assembly 400 via the phase link 510, and the other end of the phase rocker 520 is movably connected with the rotor assembly 300 via the pitch link 530. The phase link 510 is hinged with the swashplate assembly 400 via a ball joint, the phase link 510 is hinged with the phase rocker 520 via a rotating shaft, the phase rocker 520 is hinged with the pitch link 530 via a ball joint, and the pitch link 530 is hinged with the rotor assembly 300 via a ball joint.

For example, as shown in FIG. 1 to FIG. 3, the phase link 510 is arranged at a rear side of the swashplate assembly 400 and extends to the upper left, and the phase rocker 520 is rotatably arranged at a left side of a lower end of the rotor hub 200. A rear end of the phase rocker 520 is hinged with an upper end of the phase link 510, a front end of the phase rocker 520 is hinged with a lower end of the pitch link 530, and the upper end of the pitch link 530 is hinged with a front end of the rotor assembly 300. Specifically, taking the link assembly 500 on a left side of the main shaft 100 as an example, when the swashplate assembly 400 ascends along the main shaft 100, the phase link 510 ascends to drive the rear end of the phase rocker 520 to ascend and the front end of the phase rocker to descend, so that the pitch link 530 descends to drive the rotor assembly 300 to rotate. Therefore, a manipulation quantity of the steering engine is transmitted via the phase rocker 520, while the phase rocker 520 is arranged on the rotor hub 200 and the phase rocker 520 can only rotate in a plane perpendicular to a left-right direction, so the pitch link 530 and the phase link 510 can only move in a plane most perpendicular to the left-right direction, and left-right deviation will not be generated, thus avoiding a phenomenon of oblique transmission during pitch transmission and improving a transmission accuracy.

As shown in FIG. 1 to FIG. 4, the phase rocker 520 is rotatably arranged at the left side of the lower end of the rotor hub 200 through the rotating shaft arranged in the left-right direction, so that the phase rocker 520 can only rotate around the rotating shaft in the plane perpendicular to the left-right direction. As for the phase link 510, since the phase link 510 is connected with the phase rocker 520 through the rotating shaft arranged in the left-right direction, the phase link 510 can only move in the plane perpendicular to the left-right direction, and no left-right deviation will be generated. As for the pitch link 530, since both ends of the pitch link 530 are hinged with the phase rocker 520 and the rotor assembly 300 respectively, and both the phase rocker 520 and the rotor assembly 300 can only rotate in the plane perpendicular to the left-right direction relative to the rotor hub 200, the pitch link 530 will not be subjected to a force in the left-right direction, nor subjected to the left-right deviation. In this way, the phenomenon of oblique transmission during pitch transmission can be avoided.

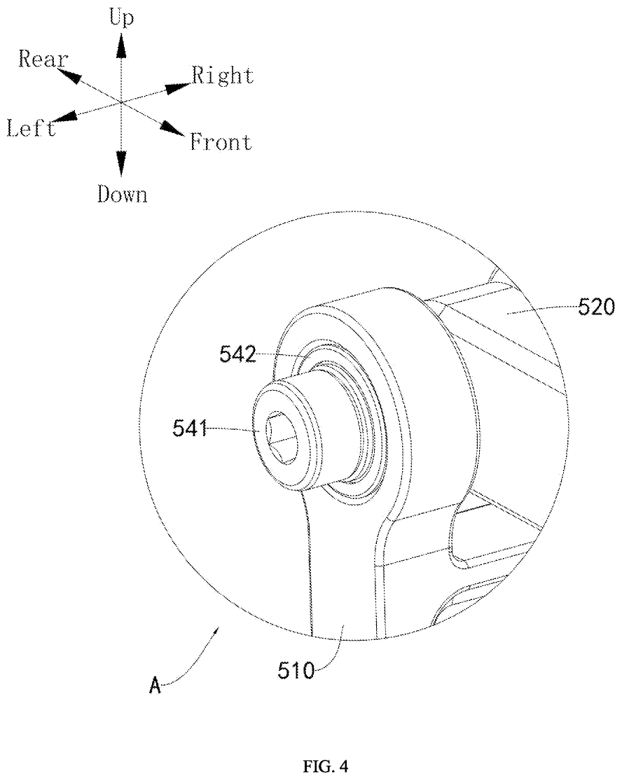

In some embodiments of the disclosure, the rotating shaft is a set screw 541, the set screw 541 is penetrated in the phase link 510 and the phase rocker 520, and a bearing 542 is arranged between the set screw 541 and the phase link 510. For example, as shown in FIG. 4, wear caused by rotation can be reduced by setting the bearing 542, so that a maintenance cost of the link rotor head can be reduced.

In some embodiments of the disclosure, the rotor assembly 300 includes: a rotor grip 310 and a blade 320, wherein the rotor grip 310 is rotatably arranged on the rotor hub 200, and the pitch link 530 is hinged with the rotor grip 310; and the blade 320 is arranged at one side of the rotor grip 310 far away from the rotor hub 200. For example, as shown in FIG. 1 to FIG. 3, the link assembly 500 for pitch transmission is connected with the rotor grip 310, and the blade 320 is installed on the rotor grip 310. In this way, the blade 320 can be replaced and adjusted independently without needing to disassemble the link assembly 500 and the rotor grip 310, so that parts at the joints are prevented from being worn by repeated disassembly and assembly to affect an accuracy of the link rotor head.

In some embodiments of the disclosure, an upper end of the pitch link 530 is hinged with a leeward side of the rotor assembly 300. For example, as shown in FIG. 1, due to the setting of the phase rocker 520, the pitch link 530 descends when the swashplate assembly 400 ascends, so that the upper end of the pitch link 530 is hinged with the leeward side of the rotor assembly 300. Specifically, when a swing arm of a steering engine swings upwards, the swashplate assembly 400 moves upwards, the phase link 510 moves upwards, the pitch link 530 moves downwards, and the leeward side of the rotor assembly 300 moves downwards to make the rotor assembly 300 generate a positive pitch. In this way, a direction controlling way of the steering engine accords with operating habits of general operators.

In some embodiments of the disclosure, two rotor assemblies 300 and two link assemblies 500 are provided, and both the two rotor assemblies 300 and the two link assemblies 500 are symmetrically arranged along an axis center of the main shaft 100. For example, as shown in FIG. 1 to FIG. 3, the rotor assembly 300 and the link assembly 500 are symmetrically arranged, so that a force borne by the link rotor head in the operating process is more uniform, the transmission accuracy is further improved, and the wear of the parts is reduced.

In some embodiments of the disclosure, the swashplate assembly 400 includes: a lower swashplate 410 and an upper swashplate 420, wherein the lower swashplate 410 is arranged around the main shaft 100, and the lower swashplate 410 is connected with a steering engine via several lower links; the upper swashplate 420 is arranged around the main shaft 100, the upper swashplate 420 is rotatably arranged at an upper end of the lower swashplate 410 relative to the lower swashplate 410, and the upper swashplate 420 is hinged with the phase link 510.

For example, as shown in FIG. 1 to FIG. 3, a manipulation quantity of the steering engine is transmitted to the lower swashplate 410 via the lower link to change a position and an angle of the lower swashplate 410. A position and an angle of the upper swashplate 420 change with the lower swashplate 410, but the upper swashplate 420 can rotate relative to the lower swashplate 410. When an aircraft flies, the main shaft 100 drives the rotor assembly 300 to rotate, and the rotating assembly drives the upper swashplate 420 to rotate via the link assembly 500. In the existing structure, a bracket of the upper swashplate 420 pulls the rotor assembly 300 via the link. Because relative rotating speeds of the upper and lower swashplates 410 are very high when the aircraft is flying, pushing the swashplate assembly 400 to change the pitch at this time will cause the swashplate assembly 400 to be seriously worn. However, in the link rotor head of the disclosure, because the phase rocker 520 is arranged on the rotor hub 200 to make the rotor hub 200 bear a part of transmission torque when the aircraft is flying, so that the swashplate is prevented from being directly stressed and the loss of the swashplate is reduced.

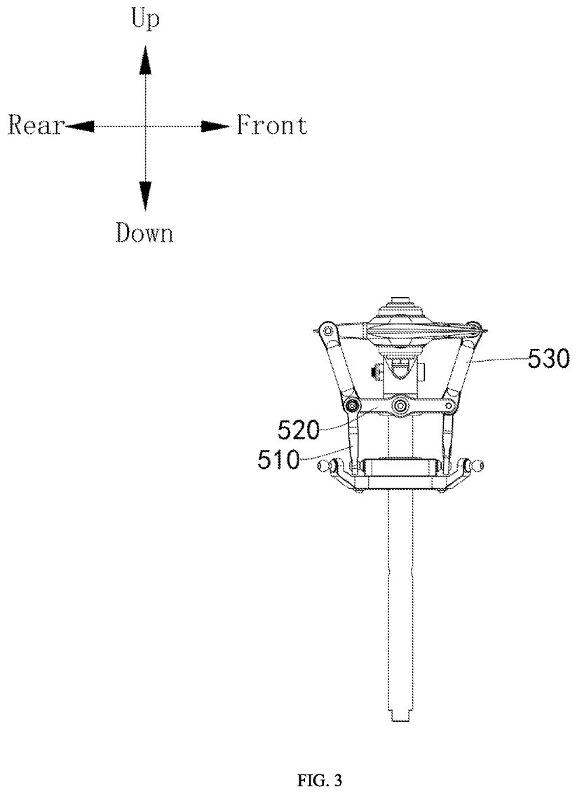

In some embodiments of the disclosure, the pitch link 530 is a plastic injection part. For example, as shown in FIG. 3, due to the arrangement of the phase link 510 and the phase rocker 520, the pitch link 530 is no longer directly connected with the swashplate assembly 400 and the rotor assembly 300, so a length of the pitch link 530 is shorter than that of a pitch transmission link in the existing technology. Using the plastic injection part as the pitch link 530 can meet strength requirements and reduce the production cost.

An unmanned aerial vehicle according to an embodiment of a second aspect of the disclosure includes the link rotor head according to the embodiment of the first aspect of the disclosure above.

According to the unmanned aerial vehicle of the embodiment of the disclosure, by adopting the link rotor head above, heading stability is improved, operating load of parts is reduced, and service lives of the parts are prolonged.

Other structures and operations of the unmanned aerial vehicle according to the embodiments of the disclosure are known to those having ordinary skills in the art, and will not be described in detail here.

The embodiments of the disclosure have been described in detail above with reference to the drawings, but the disclosure is not limited to the above embodiments, and various changes may be made within the scope of knowledge of those having ordinary skills in the art without departing from the purpose of the disclosure.

1. A link rotor head, comprising:
a main shaft;
a rotor hub, wherein the rotor hub is arranged at an upper end of the main shaft;
a rotor assembly, wherein the rotor assembly is rotatably arranged on the rotor hub;
a swashplate assembly, wherein the swashplate assembly is movably arranged around the main shaft; and
a link assembly, wherein the swashplate assembly is configured for driving the rotor assembly to rotate via the link assembly, the link assembly comprises a phase link, a phase rocker and a pitch link, the phase rocker is rotatably arranged on the rotor hub, one end of the phase rocker is movably connected with the swashplate assembly via the phase link, and an other end of the phase rocker is movably connected with the rotor assembly via the pitch link; the phase link is hinged with the swashplate assembly via a ball joint, the phase link is hinged with the phase rocker via a rotating shaft, the phase rocker is hinged with the pitch link via a ball joint, and the pitch link is hinged with the rotor assembly via a ball joint.

2. The link rotor head of claim 1, wherein the rotating shaft is a set screw passing through the phase link and the phase rocker, and a bearing is arranged between the set screw and the phase link.

3. The link rotor head of claim 1, wherein the rotor assembly comprises:
a rotor grip, wherein the rotor grip is rotatably arranged on the rotor hub, and the pitch link is hinged with the rotor grip; and
a blade, wherein the blade is arranged on one side of the rotor grip far away from the rotor hub.

4. The link rotor head of claim 1, wherein an upper end of the pitch link is hinged with a leeward side of the rotor assembly.

5. The link rotor head of claim 1, wherein the rotor assembly comprises a pair of rotor assemblies and the link assembly comprises a pair of link assembles both provided in two, and both the pair of rotor assemblies and the pair of link assemblies are symmetrically arranged along an axis center of the main shaft.

6. The link rotor head of claim 1, wherein the swashplate assembly comprises:
a lower swashplate, wherein the lower swashplate is arranged around the main shaft, and the lower swashplate is connected with a steering engine via one or more lower links; and
an upper swashplate, wherein the upper swashplate is arranged around the main shaft, the upper swashplate is rotatably arranged at an upper end of the lower swashplate, and the upper swashplate is hinged with the phase link.

7. The link rotor head of claim 1, wherein the pitch link is a plastic injection part.

8. An unmanned aerial vehicle, comprising a link rotor comprising:
a main shaft;
a rotor hub, wherein the rotor hub is arranged at an upper end of the main shaft;
a rotor assembly, wherein the rotor assembly is rotatably arranged on the rotor hub;
a swashplate assembly, wherein the swashplate assembly is movably arranged around the main shaft; and
a link assembly, wherein the swashplate assembly is configured for driving the rotor assembly to rotate via the link assembly, the link assembly comprises a phase link, a phase rocker and a pitch link, the phase rocker is rotatably arranged on the rotor hub, one end of the phase rocker is movably connected with the swashplate assembly via the phase link, and an other end of the phase rocker is movably connected with the rotor assembly via the pitch link; the phase link is hinged with the swashplate assembly via a ball joint, the phase link is hinged with the phase rocker via a rotating shaft, the phase rocker is hinged with the pitch link via a ball joint, and the pitch link is hinged with the rotor assembly via a ball joint.

9. The unmanned aerial vehicle of claim 8, wherein the rotating shaft is a set screw passing through the phase link and the phase rocker, and a bearing is arranged between the set screw and the phase link.

10. The unmanned aerial vehicle of claim 8, wherein the rotor assembly comprises:
a rotor grip, wherein the rotor grip is rotatably arranged on the rotor hub, and the pitch link is hinged with the rotor grip; and
a blade, wherein the blade is arranged on one side of the rotor grip far away from the rotor hub.

11. The unmanned aerial vehicle of claim 8, wherein an upper end of the pitch link is hinged with a leeward side of the rotor assembly.

12. The unmanned aerial vehicle of claim 8, wherein the rotor assembly comprises a pair of rotor assemblies and the link assembly comprises a pair of link assemblies, and both the pair of rotor assemblies and the pair of link assemblies are symmetrically arranged along an axis center of the main shaft.

13. The unmanned aerial vehicle of claim 8, wherein the swashplate assembly comprises:
a lower swashplate, wherein the lower swashplate is arranged around the main shaft, and the lower swashplate is connected with a steering engine via one or more lower links; and
an upper swashplate, wherein the upper swashplate is arranged around the main shaft, the upper swashplate is rotatably arranged at an upper end of the lower swashplate, and the upper swashplate is hinged with the phase link.

14. The unmanned aerial vehicle of claim 8, wherein the pitch link is a plastic injection part.
